(19) United States
(12) Patent Application Publication
(10) Pub. No.: US 2019/0086697 A1
(43) Pub. Date: Mar. 21, 2019

(54) METHOD FOR MANUFACTURING LIQUID CRYSTAL DISPLAY DEVICE

(71) Applicant: SHARP KABUSHIKI KAISHA, Sakai City, Osaka (JP)

(72) Inventors: NOBUFUMI TOMIMARU, Sakai City (JP); HIDEYUKI SUZUKI, Sakai City (JP)

(73) Assignees: SHARP KABUSHIKI KAISHA, Sakai City, Osaka (JP); SHARP KABUSHIKI KAISHA, Sakai City, Osaka (JP)

(21) Appl. No.: 16/304,300

(22) PCT Filed: May 22, 2017
(86) PCT No.: PCT/JP2017/018946

§ 371 Date: Nov. 25, 2018

(30) Foreign Application Priority Data
May 27, 2016 (JP) 2016-106624

(51) Int. Cl. G02F 1/13; G02F 1/1337

(52) U.S. Cl. CPC G02F 1/1303; G02F 1/133788

(57) ABSTRACT

The present invention provides a method for producing a liquid crystal display device in which light leakage due to photo-alignment treatment is reduced. The method for producing a liquid crystal display device of the present invention includes: a first step of forming a photo-alignment film on a surface of at least one of paired substrates; a second step of irradiating the photo-alignment film with polarized light; and a third step of forming a liquid crystal layer between the substrates, wherein the polarized light irradiation in the second step is performed while the at least one of the substrates provided with the photo-alignment film is supported by a support column at a surface opposite to the surface on which polarized light is incident, and an end of the support column on the side that contacts the at least one of the substrates has a pointed shape, recessed shape, or thin rod shape.

### TECHNICAL FIELD

The present invention relates to methods for producing liquid crystal display devices. In particular, the present invention relates to a method for producing a liquid crystal display device including alignment treatment on an alignment film by light irradiation.

### BACKGROUND ART

Liquid crystal display devices are display devices utilizing a liquid crystal composition for display. The typical display mode thereof is irradiating a liquid crystal display panel containing a liquid crystal composition sealed between paired substrates with light from a backlight and applying voltage to the liquid crystal composition to change the alignment of liquid crystal molecules, thereby controlling the amount of light passing through the liquid crystal display panel. Such liquid crystal display devices have features including a thin profile, light weight, and low power consumption, and have therefore been used for electronic devices such as television sets, smartphones, tablet PCs, and car navigation systems.

In liquid crystal display devices, the alignment of liquid crystal molecules with no voltage applied is typically controlled by alignment films on which an alignment treatment has been performed. The alignment treatment has conventionally been performed by the rubbing method of rubbing the surface of an alignment film with a tool such as a roller. However, since the number of the conductive lines and the area of the black matrix disposed in the liquid crystal panel have been increased, irregularities are now more likely to occur on the substrate surfaces in the liquid crystal panel. With irregularities on the substrate surfaces, the portions near the irregularities may not be properly rubbed by the rubbing method.

In order to deal with this problem, studies and development have been made on a photo-alignment method which is an alternative alignment treatment method to the rubbing method and irradiates the surface of an alignment film with light. With the photo-alignment method, an alignment treatment can be performed without contact with the surface of the alignment film. The photo-alignment method therefore has the advantage that the alignment treatment is less likely to be non-uniform even with irregularities on the substrate surfaces, so that a favorable liquid crystal alignment can be achieved on the entire substrates.

Regarding the photo-alignment method, for example, Patent Literature 1 discloses a liquid crystal display device including two parallel wall electrodes on either side of a pixel, a counter electrode between the two parallel wall electrodes, and a photo-alignment film. It discloses that when the initial alignment direction of liquid crystal molecules controlled by the photo-alignment film is substantially parallel or perpendicular to the extending direction of the two parallel wall electrodes and the counter electrode is tilted at a predetermined bias angle φ relative to the initial alignment of liquid crystal molecules, the liquid crystal display device can prevent light leakage around the wall electrodes and can have a high resolution, high contrast ratio, and high aperture ratio. When the photo-alignment method including the polarized light irradiation of the photo-alignment film is applied to steeply inclined wall electrodes, reflected light having a displaced polarization axis is generated at the inclined surfaces of the wall electrodes. This reflected light reaches the pixel region near the wall electrodes to disturb alignment axes, thus causing light leakage. Patent Literature 1 thus discloses a technique for preventing light leakage due to light reflected on the inclined surfaces of the wall electrodes.

Regarding the light irradiation technique, for example, Patent Literature 2 discloses a peripheral exposure apparatus that irradiates a peripheral region around a pattern region of a substrate with light containing ultraviolet rays while blocking identification marks (e.g., symbols, letters) in the peripheral region from light. The peripheral exposure apparatus of Patent Literature 2 includes a UV irradiating unit that irradiates, on a transfer path, the peripheral region of the substrate with light containing ultraviolet rays from an irradiation aperture via an irradiation lens, and an irradiation region-adjusting shutter that is controlled to cover at least part of the irradiation aperture according to the substrate conveying speed so as to block the identification marks from light. The literature discloses that the apparatus can perform exposure of the peripheral region no matter where the identification marks are formed.

Regarding the technique for polarized light irradiation of the photo-alignment film, for example, Patent Literature 3 discloses a polarized light irradiating apparatus that irradiates a photo-alignment film with polarized light from multiple irradiating units arranged along the photo-alignment film conveying direction. It discloses that when polarizers of the irradiating units are arranged such that they satisfy predetermined requirements, the photo-alignment film can be irradiated with polarized light at a uniform energy distribution.

### CITATION LIST

### Patent Literature

Patent Literature 1: JP 2015-60185 A
Patent Literature 2: JP 2007-148361 A
Patent Literature 3: JP 2007-114647 A

### SUMMARY OF INVENTION

### Technical problem

The present inventors made studies on the production process of a liquid crystal display device and found that some liquid crystal panels produced by polarized light irradiation of the photo-alignment film suffer light leakage. The present inventors made various studies on the cause of the light leakage. The studies revealed that light leakage occurs at the positions of the pins (support columns) that support the substrate in the step of irradiating the substrate provided with the photo-alignment film with polarized light.

The present inventors made studies on the method for producing a liquid crystal display device according to Comparative Embodiment 1. FIG. 9 illustrates the mechanism of light leakage caused by polarized light irradiation when the method according to Comparative Embodiment 1 is used. As shown in FIG. 9, according to the method for producing a liquid crystal display device according to Comparative Embodiment 1, substrates 10 and 20 each provided with a photo-alignment film 40 (also referred to as laminates 11 and 21 each including a substrate and a photo-alignment film) were each supported by a support column 51a from below and irradiated with polarized light 54 from above, whereby photo-alignment treatment of the photo-alignment films 40 was performed. A liquid crystal display device was produced with the obtained photo-alignment films 40 and a light leakage evaluation was performed.

The liquid crystal display device produced by the method for producing a liquid crystal display device according to Comparative Embodiment 1 was evaluated for light leakage in the non-illuminated state (black display), and circular light leakage was observed. The light leakage was observed also when observing the liquid crystal display device using an ND filter that reduces the light amount to 3%. In the liquid crystal display device of Comparative Embodiment 1, light leakage tended to occur especially in an oblique direction.

The light leakage in the case of the method for producing a liquid crystal display device according to Comparative Embodiment 1 seemingly occurred for the following reason. Polarized light 54 transmitted by the laminates 11 and 21 each including a substrate and a photo-alignment film without being absorbed was reflected by the support columns 51a supporting the substrates 10 and 20. The resulting reflected light 55 having a different polarization axis seemingly reached the photo-alignment films 40. In other words, the polarized light 54 from above the laminates 11 and 21 each including a substrate and a photo-alignment film and the reflected light 55 from the support columns 51a had different polarized axes, so that the regions of the photo-alignment films 40 corresponding to the support columns 51a were seemingly irradiated with polarized light rays having different polarization axes. When a specific position of the photo-alignment film 40 is irradiated with polarized light rays having different polarization axes, the initial alignment azimuth of the liquid crystal molecules is changed. This change in the initial alignment azimuth is considered to have caused the light leakage observed in the black display in the crossed Nicols state where a liquid crystal layer was disposed between the paired substrates each provided with the photo-alignment film 40.

As described above, in the liquid crystal display device produced by the photo-alignment method, light leakage occurs due to reflected light from the support columns supporting the substrates. None of Patent Literatures 1 to 3 discloses a technique for reducing light leakage due to reflected light from support columns.

The present invention was made in view of the situation in the art and aims to provide a method for producing a liquid crystal display device in which light leakage due to photo-alignment treatment is reduced.

### Solution to Problem

The present inventors made various studies on the method for producing a liquid crystal display device with reduced light leakage. They found out that supporting a substrate with support columns of a specific shape in the polarized light irradiation of the photo-alignment film enables control of the reflected light that reaches the photo-alignment film. This has made it possible to produce a liquid crystal display device with reduced light leakage. The present inventors thus have found the solution of the above problems, arriving at the present invention.

One aspect of the present invention may be a method for producing a liquid crystal display device, including: a first step of forming a photo-alignment film on a surface of at least one of paired substrates; a second step of irradiating the photo-alignment film with polarized light; and a third step of forming a liquid crystal layer between the substrates, wherein the polarized light irradiation in the second step is performed while the at least one of the substrates provided with the photo-alignment film is supported by a support column at a surface opposite to the surface on which polarized light is incident, and an end of the support column on the side that contacts the at least one of the substrates has a pointed shape, recessed shape, or thin rod shape.

An end portion of the support column on the side that contacts the at least one of the substrates may have a conical shape, a pyramidal shape, a hollow cylindrical shape, a round pillar shape, or a polygonal pillar shape.

The support column may be black.

At least a surface of the support column may contain black fluororesin.

### Advantageous Effects of Invention

The present invention provides a method for producing a liquid crystal display device in which light leakage due to photo-alignment treatment is reduced.

### BRIEF DESCRIPTION OF DRAWINGS

FIG. 1 schematically illustrates the method for producing a liquid crystal display device according to Embodiment 1. FIG. 1(a) is a schematic side view illustrating a substrate and a photo-alignment film formed thereon in a first step. FIG. 1(b) is a schematic perspective view illustrating a second step in which a photo-alignment film is irradiated with polarized light. FIG. 1(c) is a schematic cross-sectional view illustrating substrates and a liquid crystal layer formed therebetween in a third step.

FIG. 2 schematically illustrates a support column used in the method for producing a liquid crystal display device according to Embodiment 1. FIG. 2(a) is a schematic perspective view illustrating a pencil-type support column. FIG. 2(b) is a cross-sectional view illustrating the pencil-type support column.

FIG. 3 schematically illustrates irradiation of a photo-alignment film with polarized light while supporting a substrate with a pencil-type support column in the method for producing a liquid crystal display device according to Embodiment 1.

FIG. 4 is a schematic cross-sectional view illustrating a liquid crystal display device produced by the method for producing a liquid crystal display device according to Embodiment 1.

FIG. 5 schematically illustrates a support column used in the method for producing a liquid crystal display device according to Embodiment 2. FIG. 5(a) is a schematic perspective view of a cavity-type support column. FIG. 5(b) is a schematic cross-sectional view of the cavity-type support column.

FIG. 6 schematically illustrates irradiation of a photo-alignment film with polarized light while supporting a substrate with a cavity-type support column in the method for producing a liquid crystal display device according to Embodiment 2.

FIG. 7 schematically illustrates a support column used in a method for producing a liquid crystal display device according to Embodiment 3. FIG. 7(a) is a schematic perspective view of a thin rod-type support column. FIG. 7(b) is a schematic cross-sectional view of the thin rod-type support column.

FIG. 8 schematically illustrates irradiation of a photo-alignment film with polarized light while supporting a substrate with a thin rod-type support column in the method for producing a liquid crystal display device according to Embodiment 3.

FIG. 9 is a view illustrating the mechanism of light leakage caused by polarized light irradiation when a method for producing a liquid crystal display device according to Comparative Embodiment 1 is used.

### DESCRIPTION OF EMBODIMENTS

Embodiments of the present invention will be described below. The embodiments, however, are not intended to limit the scope of the present invention, and design changes can be suitably made within the spirit of the configuration of the present invention. Hereinafter, the same portions or the portions having the same function in different drawings are provided with the same reference sign, and thus the same reference sigh is not repeatedly described. The configurations of the respective embodiments may suitably be combined or altered within the spirit of the present invention.

### Embodiment 1

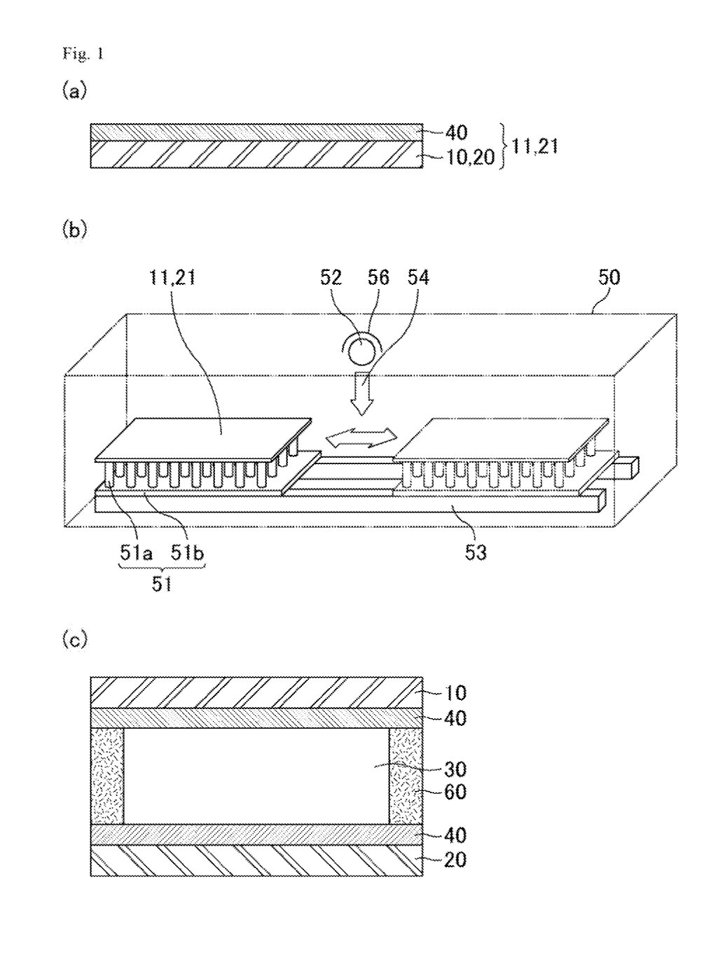

With reference to FIG. 1, the method for producing a liquid crystal display device according to Embodiment 1 is described. FIG. 1 schematically illustrates the method for producing a liquid crystal display device according to Embodiment 1. FIG. 1(a) is a schematic side view illustrating a substrate and a photo-alignment film formed thereon in a first step. FIG. 1(b) is a schematic perspective view illustrating a second step in which a photo-alignment film is irradiated with polarized light. FIG. 1(c) is a schematic cross-sectional view illustrating substrates and a liquid crystal layer formed therebetween in a third step.

The method for producing a liquid crystal display device of the present embodiment includes a first step of forming a photo-alignment film on a surface of at least one of paired substrates, a second step of irradiating the photo-alignment film with polarized light, and a third step of forming a liquid crystal layer between the substrates.

First, the first step of forming a photo-alignment film is described. In the first step of the method for producing a liquid crystal display device of the present embodiment, as shown in FIG. 1(a), a photo-alignment film 40 is formed on at least one of paired substrates 10 and 20.

The paired substrates 10 and 20 may be, for example, a combination of an active matrix substrate (TFT substrate) and a color filter (CF) substrate.

The active matrix substrate may be one commonly used in the field of liquid crystal display devices. When the active matrix substrate is seen in a planar view, for example, the active matrix substrate has on a transparent substrate a structure which includes multiple parallel gate signal lines, multiple source signal lines extending in a direction perpendicular to the gate signal lines and formed in parallel to each other, active elements such as thin-film transistors (TFTs) arranged at positions corresponding to the intersections between the gate signal lines and the source signal lines, and pixel electrodes arranged in a matrix in regions partitioned by the gate signal lines and the source signal lines. In the case of a horizontal alignment mode, such a structure further includes components such as a common conductive line and a counter electrode connected to the common conductive line.

TFTs having a channel layer formed from amorphous silicon, polysilicon, or indium-gallium-zinc-oxygen (IGZO; oxide semiconductor) are preferably used.

The color filter substrate may be one that is commonly used in the field of liquid crystal display devices. The structure of the color filter substrate includes, for example, a black matrix in a grid pattern and color filters each formed within a cell of the grid (i.e., pixels) formed on a transparent substrate.

The color filters and the active matrix may both be formed on one of the substrates 10 and 20.

The photo-alignment film 40 is an alignment film that is photo-alignment-treated by polarized light irradiation. The photo-alignment film 40 controls the alignment of liquid crystal molecules in the liquid crystal layer. When the voltage applied to the liquid crystal layer is lower than the threshold voltage (including no voltage application), the alignment of the liquid crystal molecules in the liquid crystal layer is controlled mainly by the function of the photo-alignment film 40. An angle formed by the major axes of the liquid crystal molecules with respect to the surfaces of the substrates 10 and 20 in this state (hereinafter also referred to as an “initial alignment state”) is referred to as a “pre-tilt angle”. The term “pre-tilt angle” as used herein indicates the angle of tilt of the liquid crystal molecules from the direction parallel to the substrate surfaces. The angle parallel to the substrate surfaces is 0°, and the angle normal to the substrate surfaces is 90°.

The direction in which the photo-alignment film 40 aligns the liquid crystal molecules preferably varies depending on the polarization axis direction of incident polarized light. For example, the photo-alignment film 40 may exert alignment-controlling force in a direction parallel to the polarization axis direction of incident polarized light or in a direction perpendicular to the polarization axis direction of incident polarized light.

The degree of the pre-tilt angle of the liquid crystal molecules imparted by the photo-alignment film 40 is not particularly limited. The photo-alignment film 40 may substantially horizontally align the liquid crystal molecules in the liquid crystal layer (i.e., a horizontal alignment film) or substantially vertically align the liquid crystal molecules in the liquid crystal layer (i.e., a vertical alignment film). In the case of the horizontal alignment film, when the liquid crystal molecules are substantially horizontally aligned, the pre-tilt angle is preferably substantially 0° (e.g., less than 10°). The pre-tilt angle is more preferably 0° in order to achieve an effect to maintain favorable contrast characteristics for a long time. When the display mode is an IPS mode or an FFS mode, the pre-tilt angle is preferably 0° also in terms of viewing angle characteristics. When the display mode is a TN mode, the pre-tilt angle is set to, for example, about 2° due to restrictions associated with the mode. In the case of the vertical alignment film, when the liquid crystal molecules are substantially vertically aligned, the pre-tilt angle is preferably 83.0° or more. The pre-tilt angle is more preferably 88.0° or more in terms of viewing angle characteristics, response characteristics, dark line thickness (which affects the transmittance) in four-domain division alignment, and alignment stability.

The photo-alignment film 40 is formed of a photo-alignment material. The photo-alignment material encompasses general materials that undergo a structural change when irradiated with light (electromagnetic waves) such as ultraviolet light or visible light, and thereby exhibit an ability (alignment-controlling force) of controlling the alignment of liquid crystal molecules adjacent to the photo-alignment film or change the alignment-controlling force level and/or direction. Examples of the photo-alignment material include those containing a photo-reactive site which undergoes a reaction such as dimerization (formation of dimers), isomerization, photo-Fries rearrangement, or decomposition when irradiated with light. Examples of the photo-reactive site (functional group) which is dimerized and isomerized when irradiated with light include cinnamate, chalcone, coumarin, and stilbene. Examples of the photo-reactive site (functional group) which is isomerized when irradiated with light include azobenzene. Examples of the photo-reactive site which is photo-Fries rearranged when irradiated with light include phenolic ester structures. Examples of the photo-reactive site which is decomposed when irradiated with light include cyclobutane structures.

A specific example of the first step is described below.

First, a photo-alignment material is dissolved in a solvent such as an organic solvent to prepare a liquid crystal alignment agent. The liquid crystal alignment agent may contain other optional components. Preferably, the liquid crystal alignment agent is prepared as a solution-like composition whose components are dissolved in a solvent. The organic solvent is preferably one that dissolves the photo-alignment material and the other optional components but does not react therewith. Examples of the other optional components include curing agents, curing accelerators, and catalysts. The photo-alignment material is preferably a material containing an azobenzene group, a chalcone group, or a cinnamate group. The photo-alignment film 40 preferably contains a polymer selected from the group consisting of a polyamic acid, a polyimide, a polysiloxane, a polyvinyl, and polymaleimide.

Next, the liquid crystal alignment agent is applied to the surfaces of the substrates 10 and 20. Non-limiting examples of the application technique include a roll coater technique, a spinner technique, a printing technique, and an ink-jet technique.

After the liquid crystal alignment agent is applied on the surfaces of the substrates 10 and 20, the substrates 10 and 20 are heated. Thus, the solvent in the liquid crystal alignment agent is evaporated and the photo-alignment films 40 are formed. Heating may be performed in two stages of pre-baking and post-baking.

The photo-alignment film 40 may be formed only on one of the substrates 10 and 20. Division alignment treatment may be performed for multi-domain formation.

Next, the second step of irradiating the photo-alignment films 40 with polarized light is described. As shown in FIG. 1(b), in the second step, the photo-alignment films 40 are irradiated with polarized light 54 while the substrates 10 and 20 each provided with the photo-alignment film 40 are supported by support columns 51a at the surface opposite to the surface on which polarized light is incident. This gives the desired alignment-controlling force to the photo-alignment films 40. Specifically, the photo-alignment films 40 are irradiated with (exposed to) light such as ultraviolet light or visible light. As a result, the structural change occurs in the photo-alignment material, thus changing at least part of the molecular structure and/or alignment of the photo-alignment material. This allows the photo-alignment films 40 to control the alignment of liquid crystal molecules in contact with the surfaces thereof. The substrates 10 and 20 each provided with the photo-alignment film 40 are also referred to as the laminates 11 and 21 each including a substrate and a photo-alignment film.

The light used in the photo-alignment treatment may be ultraviolet light, visible light, or both of them. The light used in the photo-alignment treatment is polarized light. For example, the light may be polarized light such as linearly polarized light, elliptically polarized light, or circularly polarized light. It is particularly preferable to irradiate the photo-alignment films 40 with polarized ultraviolet light.

The support columns 51a that support the substrates 10 and 20 each provided with the photo-alignment film 40 contact the substrates 10 and 20 and hold the substrates 10 and 20 horizontally. With the support columns 51a supporting the substrates 10 and 20, the substrates 10 and 20 can be conveyed with a robot hand inserted between the support columns 51a. In addition, generation of static electricity due to peeling electrification can be prevented during conveyance of the substrates 10 and 20.

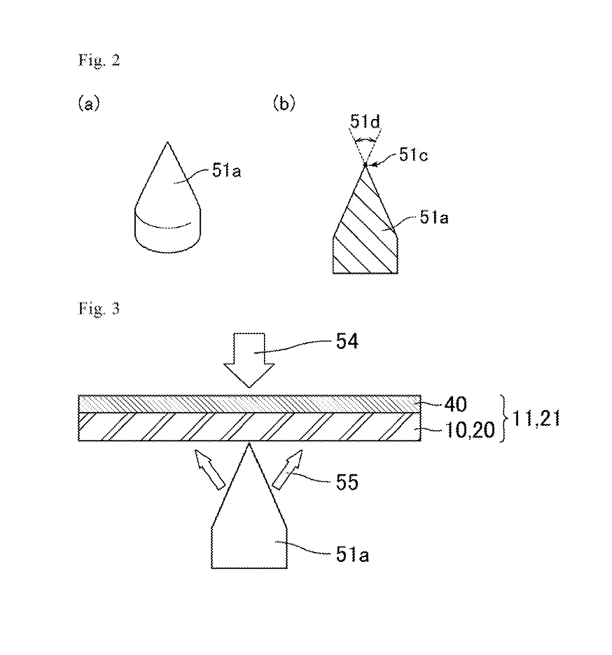

FIG. 2 schematically illustrates a support column used in the method for producing a liquid crystal display device according to Embodiment 1. FIG. 2(a) is a schematic perspective view illustrating a pencil-type support column. FIG. 2(b) is a cross-sectional view illustrating the pencil-type support column. In the present embodiment, the end of the support column 51a on the side that contacts the substrates 10 and 20 has a pointed shape capable of making a point contact with the substrates 10 and 20. If the end of the support column 51a is flat, polarized light 54 tends to be regularly reflected on the end of the support column 51a, increasing the reflected light intensity in the region supported by the support column 51a. This tends to cause alignment disturbance in the photo-alignment films 40. In contrast, when the end of the support column 51a has a shape that can diffusely reflect light incident from above, such as a pointed shape, polarized light 54 is diffusely reflected on the end of the support column 51a, preventing the reflected light from concentrating in the region supported by the support column 51a. As a result, the alignment disturbance in the photo-alignment films 40 can be reduced. In addition, when the end of the support column 51a has a pointed shape, the support column 51a can have a smaller contact area with the substrates 10 and 20, so that light leakage due to reflected light from the support column 51a can be reduced.

The pointed shape capable of making a point contact is preferably a conical or pyramidal shape. The conical shape may be a shape (substantially conical shape) that can be identified with a conical shape in terms of the effects of the present invention. Examples thereof include a shape similar to that of a cone, such as a shape of a cone partially having irregularities. The pyramidal shape may be a shape (substantially pyramidal shape) that can be identified with a pyramidal shape in terms of the effects of the present invention. For example, some of the corners of the pyramidal shape may be curved.

When the end of the support column 51a has a pointed shape, for example, as shown in FIG. 2(b), in a section of the support column 51a, the contact portion between the support column 51a and each of the substrates 10 and 20 preferably has a length 51c of 3 mm or shorter, more preferably 2 mm or shorter, still more preferably 1 mm or shorter, particularly preferably 0.5 mm or shorter. In the section of the support column 51a, the support column 51a preferably has a tip angle 51d of 50° or smaller, more preferably 40° or smaller, still more preferably 30° or smaller, particularly preferably 20° or smaller. The contact portion is preferably arched. Herein, the length 51c of the contact portion between the support column 51a and each of the substrates 10 and 20 in the section of the support column 51a is the length obtained when the support column 51a is cut to minimize the length of the contact portion in the section.

When the end of the support column 51a has a pointed shape, preferably, the length 51c of the contact portion of the support column 51a is 3 mm or shorter, the contact portion is arched, and the tip angle 51d is 50° or smaller. More preferably, the length 51c of the contact portion of the support column 51a is 2 mm or shorter, the contact portion is arched, and the tip angle 51d is 40° or smaller. Still more preferably, the length 51c of the contact portion of the support column 51a is 1 mm or shorter, the contact portion is arched, and the tip angle 51d is 30° or smaller. Particularly preferably, the length 51c of the contact portion of the support column 51a is 0.5 mm or shorter, the contact portion is arched, and the tip angle 51d is 20° or smaller.

FIG. 3 schematically illustrates irradiation of a photo-alignment film with polarized light while supporting a substrate with a pencil-type support column in the method for producing a liquid crystal display device according to Embodiment 1. When the support column 51a is of a pencil-type in which the end that contacts the substrates 10 and 20 is pointed (e.g., conical), polarized light 54 applied to the support column 51a is mainly reflected on the inclined portion of the pointed (e.g., conical) end. Thus, the reflected light 55 that reaches the photo-alignment film 40 can be reduced.

From the viewpoint of reducing the reflectance, the support column 51a is preferably black. More preferably, at least a surface of the support column 51a contains black fluororesin. The black fluororesin can be obtained by adding a black pigment such as carbon black to fluororesin.

In the following, with reference to FIG. 1(b), a specific example of the polarized light irradiator used in the second step is described.

In FIG. 1(b), a polarized light irradiator 50 includes a stage 51 that supports the substrates 10 and 20 and an irradiating unit 52 that irradiates the photo-alignment films 40 on the substrates 10 and 20 with polarized light 54. The stage 51 is configured to support the substrates 10 and 20 and includes support columns 51a to support the substrates 10 and 20. The support columns 51a may be arranged upright on the base 51b. The irradiating unit 52 includes a light source that emits light, a light collecting mirror 56 to increase the efficiency of collection of light from the light source, and an optical unit to extract predetermined wavelength and polarized light.

The light source that emits light may be, for example, a lamp that emits ultraviolet light or visible light. The light from the light source preferably has a wavelength of 240 nm to 400 nm. The optical unit includes an optical filter to extract a predetermined wavelength and a polarizer to extract predetermined polarized light. Examples of the polarizer include a polarizing plate obtained by aligning a dichroic anisotropic material such as an iodine complex adsorbed on a polyvinyl alcohol (PVA) film, a wire grid-type polarizing plate having a fine metal grid, and a polarizing beam splitter (PBS) including an optical multilayer film designed to transmit a p-polarized light component and reflect an s-polarized light component.

The polarized light irradiator 50 includes multiple support columns 51a on the base 51b to hold the substrates 10 and 20 horizontally at a predetermined height from the base 51b. There is a predetermined spacing between the substrates 10 and 20 and the base 51b, so that the substrates 10 and 20 can be conveyed with the back side supported by multiple (e.g., two, four, or six) forks of a robot hand.

The base 51b has a flat portion that has an area equal to or greater than the area of each of the substrates 10 and 20. The support columns 51a are provided in the direction (vertical direction) perpendicular to the flat portion of the base 51b. The base 51b has any shape as long as it can support the support columns 51a in the vertical direction.

The stage 51 may be formed on a transfer rail 53 so that the substrates 10 and 20 can be conveyed via the area under the irradiating unit 52. The transfer rail 53 conveys the substrates 10 and 20 along the transfer path and moves the substrates 10 and 20 at a predetermined speed when it is irradiated with polarized light 54.

Next, the third step of forming a liquid crystal layer 30 between the substrates 10 and 20 is described. As shown in FIG. 1(c), in the third step, a liquid crystal layer 30 is formed between the substrates 10 and 20 which have the photo-alignment film 40 on a surface of at least one of them.

In the third step, a liquid crystal composition is placed between the substrates 10 and 20 by vacuum filling or one drop filling to form the liquid crystal layer 30. In the case of vacuum filling, application of a sealant, attachment of the substrates 10 and 20, curing of the sealant, filling with the liquid crystal composition, and sealing of the filling port are performed in this order. Thus, the liquid crystal composition is sealed between the substrates with a seal 60 to form the liquid crystal layer 30. In the case of one drop filling, application of a sealant, dropping of the liquid crystal composition, attachment of the substrates 10 and 20, and curing of the sealant are performed in this order. Thus, the liquid crystal composition is sealed between the substrates to form the liquid crystal layer 30.

The seal 60 is disposed to surround the liquid crystal layer 30. The material (sealant) of the seal 60 may be an epoxy resin containing inorganic or organic filler and a curing agent. The sealant may be photocurable, that is, curable by light such as ultraviolet light, or may be thermally curable, that is, curable by heat. When a photocurable sealant is used, for example, the sealant is cured by ultraviolet light irradiation with the display area shielded from light, and thereby the substrates 10 and 20 are attached.

The third step is followed by attachment of polarizing plates and attachment of components such as a control unit, a power supply unit, and a backlight. Thus, a liquid crystal display device is completed.

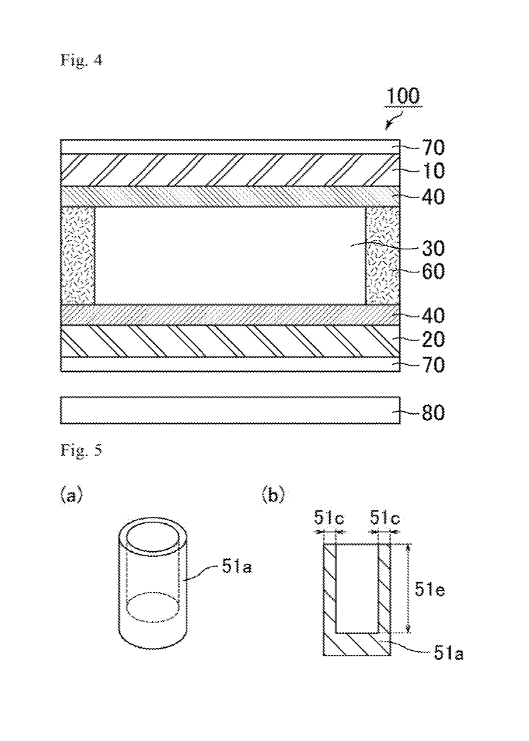

FIG. 4 is a schematic cross-sectional view illustrating a liquid crystal display device produced by the method for producing a liquid crystal display device according to Embodiment 1. As shown in FIG. 4, a liquid crystal display device 100 produced by the method for producing a liquid crystal display device of the present embodiment includes the paired substrates 10 and 20, the liquid crystal layer 30 between the substrates 10 and 20, and the photo-alignment film 40 between each of the substrates 10 and 20 and the liquid crystal layer 30. The substrates 10 and 20 are attached to each other via the seal 60. The photo-alignment film 40 may be formed on only one of the substrates 10 and 20.

A polarizing plate (linear polarizer) 70 is disposed on each of the substrates 10 and 20 on the side opposite to the liquid crystal layer 30. The polarizing plate 70 may typically be one obtained by aligning a dichroic anisotropic material such as an iodine complex adsorbed on a polyvinyl alcohol (PVA) film. Generally, each surface of the PVA film is laminated with a protective film such as a triacetyl cellulose film before the film is put into practical use. An optical film such as a retardation film may be disposed between the polarizing plate 70 and each of the substrates 10 and 20.

The liquid crystal display device 100 includes a backlight 80 on the back side of the liquid crystal panel. The liquid crystal display device 100 having such a structure is generally referred to as a transmissive liquid crystal display device. The backlight 80 is not particularly limited as long as it emits light including visible light. It may be one that emits light including only visible light, or may be one that emits light including both visible light and ultraviolet light. For the liquid crystal display device to display color images, the backlight 80 preferably emits white light. Examples of preferred light sources for the backlight 80 include light-emitting diodes (LEDs). The term “visible light” refers to light having a wavelength of 380 nm or longer and shorter than 800 nm (electromagnetic waves).

The liquid crystal display device 100 produced by the method for producing a liquid crystal display device according to Embodiment 1 has a structure including, as well as the liquid crystal panel and the backlight 80, components such as external circuits, including a tape-carrier package (TCP) and a printed circuit board (PCB); optical films, including a viewing angle-increasing film and a luminance-increasing film; and a bezel (frame). Some components may be incorporated into another component.

The display mode of the liquid crystal display device 100 is not limited. Examples thereof include a twisted nematic (TN) mode, an electrically controlled birefringence (ECB) mode, an in-plane switching (IPS) mode, a fringe field switching (FFS) mode, a vertical alignment (VA) mode, or a vertical alignment twisted nematic (VATN) mode.

In the FFS mode, at least one of the substrates 10 and 20 includes a structure including a planar electrode, a slit electrode, and an insulating film between the planar electrode and the slit electrode (FFS electrode structure), and an oblique electric field (fringe electric field) is formed in the liquid crystal layer 30. Usually, the slit electrode, the insulating film, and the planar electrode are arranged in this order from the liquid crystal layer 30. The slit electrode may be, for example, one including, as slits, linear opening portions each entirely surrounded by an electrode portion, or one having a comb shape including multiple comb teeth in which linear cuts are arranged as slits between the comb teeth.

In the IPS mode, at least one of the substrates 10 and 20 includes a pair of comb-shaped electrodes, and a transverse electric field is formed in the liquid crystal layer 30. The pair of comb-shaped electrodes may be, for example, one in which each electrode includes multiple comb teeth which are arranged to mesh with each other.

In the VATN mode, one of the substrates 10 and 20 is provided with pixel electrodes while the other of the substrates 10 and 20 is provided with a common electrode, and a vertical electric field is formed in the liquid crystal layer 30. The photo-alignment films 40 disposed on the respective substrates 10 and 20 are vertical alignment films, and their alignment treatment directions are perpendicular to each other. In the VATN mode, the photo-alignment treatment is suitably employed because the pre-tilt angle needs to be precisely controlled.

### Embodiment 2

The method for producing a liquid crystal display device of Embodiment 2 is the same as the method for producing a liquid crystal display device of Embodiment 1 except that the shape of the support column 51a is changed. In the present embodiment, thus, the characteristic features of the support column 51a of the present embodiment are mainly described, and description of any overlap with Embodiment 1 is appropriately omitted.

FIG. 5 schematically illustrates a support column used in the method for producing a liquid crystal display device according to Embodiment 2. FIG. 5(a) is a schematic perspective view of a cavity-type support column. FIG. 5(b) is a schematic cross-sectional view of the cavity-type support column. In the present embodiment, the end of the support column 51a on the side that contacts the substrates 10 and 20 has a recessed shape capable of making a linear contact with the substrates 10 and 20. The support column 51a with the end having a recessed shape can reduce the amount of polarized light 54 reflected on the end of the support column 51a, or prevent the reflected polarized light 54 from entering the region supported by the support column 51a.

The recessed shape capable of making a linear contact is preferably a hollow cylindrical shape. The hollow cylindrical shape may be a shape (substantially hollow cylindrical shape) that can be identified with a hollow cylindrical shape in terms of the effects of the present invention. Examples thereof include a shape similar to that of a hollow cylinder, such as a shape of a hollow cylinder partially having irregularities.

When the end of the support column 51a has a recessed shape, for example, as shown in FIG. 5(b), in a section of the support column 51a, the contact portion between the support column 51a and each of the substrates 10 and 20 preferably has a length 51c of 2 mm or shorter, more preferably 1.5 mm or shorter, still more preferably 1 mm or shorter, particularly preferably 0.5 mm or shorter. In the section of the support column 51a, the support column preferably has a cavity depth 51e of 4 mm or greater, more preferably 4.5 mm or greater, still more preferably 5 mm or greater, particularly preferably 5.5 mm or greater. The contact portion is preferably arched. Herein, the length 51c of the contact portion between the support column 51a and each of the substrates 10 and 20 in the section of the support column 51a is a length obtained when the support column 51a is cut to minimize the length of the contact portion in the section.

When the end of the support column 51a has a recessed shape, preferably, the length 51c of the contact portion of the support column 51a is 2 mm or shorter, the contact portion is arched, and the cavity depth 51e is 4 mm or greater. More preferably, the length 51c of the contact portion of the support column 51a is 1.5 mm or shorter, the contact portion is arched, and the cavity depth 51e is 4.5 mm or greater. Still more preferably, the length 51c of the contact portion of the support column 51a is 1 mm or shorter, the contact portion is arched, and the cavity depth 51e is 5 mm or greater. Particularly preferably, the length 51c of the contact portion of the support column 51a is 0.5 mm or shorter, the contact portion is arched, and the cavity depth 51e is 5.5 mm or greater.

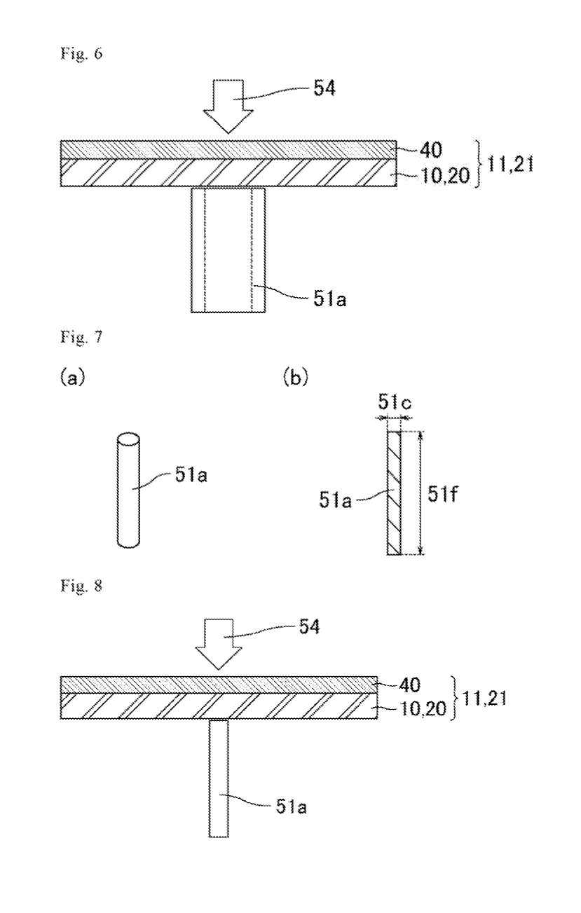

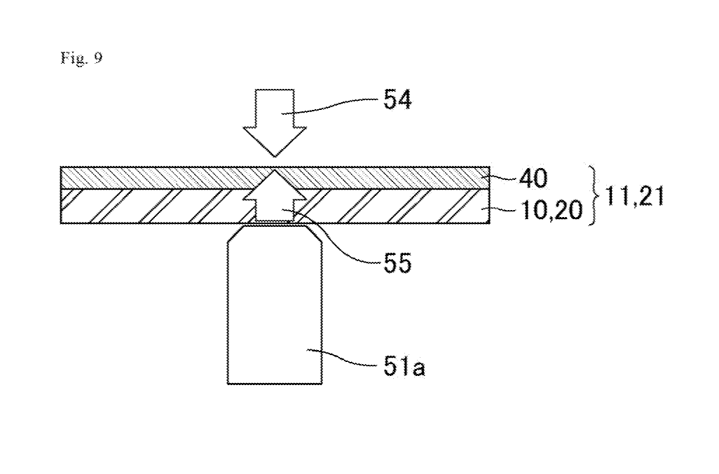

FIG. 6 schematically illustrates irradiation of a photo-alignment film with polarized light while supporting a substrate with a cavity-type support column in the method for producing a liquid crystal display device according to Embodiment 2. When the support column 51a is of a cavity-type in which the end portion that contacts the substrates 10 and 20 has a cavity in the center (e.g., has a hollow cylindrical shape), polarized light 54 applied to the support column 51a travels into the cavity inside the support column 51a without being reflected on the support column 51a. Thus, the reflected light 55 that reaches the photo-alignment film 40 can be reduced.

### Embodiment 3

The method for producing a liquid crystal display device of Embodiment 3 is the same as the method for producing a liquid crystal display device of Embodiment 1 except that the shape of the support column 51a is changed. In the present embodiment, thus, the characteristic features of the support column 51a of the present embodiment are mainly described, and description of any overlap with Embodiment 1 is appropriately omitted.

FIG. 7 schematically illustrates a support column used in a method for producing a liquid crystal display device according to Embodiment 3. FIG. 7(a) is a schematic perspective view of a thin rod-type support column. FIG. 7(b) is a schematic cross-sectional view of the thin rod-type support column. In the present embodiment, the end of the support column 51a on the side that contacts the substrates 10 and 20 has a thin rod shape capable of making a point contact with the substrates 10 and 20. The support column 51a with the end having a thin rod shape can reduce the amount of polarized light 54 reflected on the end of the support column 51a, or prevent the reflected polarized light 54 from entering the region supported by the support column 51a.

The thin rod shape capable of making a point contact means a thin rod-like structure like a lead of a mechanical pencil. The thin rod shape is preferably a long round pillar shape or a polygonal pillar shape. The round pillar shape may be a shape (substantially round pillar shape) that can be identified with a round pillar shape in terms of the effects of the present invention. Examples thereof include a shape similar to that of a round pillar, such as a shape of a round pillar partially having irregularities. The polygonal pillar shape may be a shape (substantially polygonal pillar shape) that can be identified with a polygonal pillar shape in terms of the effects of the present invention. For example, some of the corners of the polygonal pillar shape may be curved.

When the end of the support column 51a has a thin rod shape, for example, as shown in FIG. 7(b), in a section of the support column 51a, the contact portion between the support column 51a and each of the substrates 10 and 20 preferably has a length 51c of 2.5 mm or shorter, more preferably 2.3 mm or shorter, still more preferably 2 mm or shorter, particularly preferably 1.5 mm or shorter. In the section of the support column 51a, the support column 51a preferably has a length 51f in the longitudinal direction of 4.5 mm or greater, more preferably 4.7 mm or greater, still more preferably 5 mm or greater, particularly preferably 6 mm or greater. The contact portion is preferably arched. Herein, the length 51c of the contact portion between the support column 51a and each of the substrates 10 and 20 in the section of the support column 51a is a length obtained when the support column 51a is cut to minimize the length of the contact portion in the section.

When the end of the support column 51a has a thin rod shape, preferably, the length 51c of the contact portion of the support column 51a is 2.5 mm or shorter, the contact portion is arched, and the length 51f in the longitudinal direction is 4.5 mm or greater. More preferably, the length 51c of the contact portion of the support column 51a is 2.3 mm or shorter, the contact portion is arched, and the length 51f in the longitudinal direction is 4.7 mm or greater. Still more preferably, the length 51c of the contact portion of the support column 51a is 2 mm or shorter, the contact portion is arched, and the length 51f in the longitudinal direction is 5 mm or greater. Particularly preferably, the length 51c of the contact portion of the support column 51a is 1.5 mm or shorter, the contact portion is arched, and the length 51f in the longitudinal direction is 6 mm or greater.

FIG. 8 schematically illustrates irradiation of a photo-alignment film with polarized light while supporting a substrate with a thin rod-type support column in the method for producing a liquid crystal display device according to Embodiment 3. When the end of the support column 51a on the side that contacts the substrates 10 and 20 has a thin rod shape, the support column 51a has a smaller reflection surface that reflects the applied polarized light 54. Thus, the reflected light 55 that reaches the photo-alignment film 40 can be reduced.

FFS mode liquid crystal display devices were produced by the methods for producing a liquid crystal display device of Embodiments 1 to 3 with a liquid crystal dropping step (one drop filling). The light leakage in the non-illuminated state (black display) was evaluated from various angles. No display unevenness was found by naked-eye observation in any of the liquid crystal display devices.

### [Additional Remarks]

One aspect of the present invention may be a method for producing a liquid crystal display device 100 including: a first step of forming a photo-alignment film 40 on a surface of at least one of paired substrates 10 and 20; a second step of irradiating the photo-alignment film 40 with polarized light 54; and a third step of forming a liquid crystal layer 30 between the substrates 10 and 20, wherein the polarized light irradiation in the second step is performed while the at least one of the substrates 10 and 20 provided with the photo-alignment film 40 is supported by a support column 51a at a surface opposite to the surface on which polarized light 54 is incident, and an end of the support column 51a on the side that contacts the at least one of the substrates 10 and 20 has a pointed shape, recessed shape, or thin rod shape.

If the end of the support column is flat, polarized light tends to be regularly reflected on the end of the support column, increasing the reflected light intensity in the region supported by the support column. This tends to cause alignment disturbance in the photo-alignment film. In contrast, in one aspect of the present invention, the end of the support column 51a has a pointed shape, a recessed shape, or a thin rod shape. When the end of the support column 51a has a shape that can diffusely reflect light incident from above, such as a pointed shape, polarized light 54 is diffusely reflected on the end of the support column 51a, preventing the reflected light from concentrating in the region supported by the support column 51a. This can reduce the alignment disturbance in the photo-alignment films 40. In addition, when the end of the support column 51a has a pointed shape, the support column 51a can have a smaller contact area with the substrates 10 and 20, so that light leakage due to reflected light from the support column 51a can be reduced. The support column 51a with the end having a recessed shape or thin rod shape can reduce the amount of polarized light reflected on the end of the support column 51a or prevent the reflected polarized light 54 from entering the region supported by the support column 51a. As a result, the reflected light 55 that reaches the photo-alignment film 40 can be reduced. This enables production of a liquid crystal display device 100 in which light leakage due to photo-alignment treatment is reduced.

An end portion of the support column 51a on the side that contacts the at least one of substrates 10 and 20 may have a conical shape, a pyramidal shape, a hollow cylindrical shape, a round pillar shape, or a polygonal pillar shape.

The support column 51a may be black. Such support column 51a has a reduced reflectance and thus further reduces the reflected light 55 that reaches the photo-alignment film 40.

At least a surface of the support column 51a may contain black fluororesin.

### REFERENCE SIGNS LIST

10, 20: substrate
11, 21: laminate including a substrate and photo-alignment film
30: liquid crystal layer
40: photo-alignment film
50: polarized light irradiator
51: stage
51a: support column
51b: base
51c: length of a contact portion between a support column and a substrate in a section of the support column
51d: tip angle of a support column in a section of the support column
51e: depth of a cavity of a support column in a section of the support column
51f: length of a support column in the longitudinal direction in a section of the support column
52: irradiating unit
53: transfer rail
54: polarized light
55: reflected light
56: light collecting mirror
60: seal
70: polarizing plate
80: backlight
100: liquid crystal display device

1. A method for producing a liquid crystal display device, comprising:
a first step of forming a photo-alignment film on a surface of at least one of paired substrates;
a second step of irradiating the photo-alignment film with polarized light; and
a third step of forming a liquid crystal layer between the substrates,
wherein the polarized light irradiation in the second step is performed while the at least one of the substrates provided with the photo-alignment film is supported by a support column at a surface opposite to the surface on which polarized light is incident, and
an end of the support column on the side that contacts the at least one of the substrates has a pointed shape, recessed shape, or thin rod shape.

2. The method for producing a liquid crystal display device according to claim 1,
wherein an end portion of the support column on the side that contacts the at least one of the substrates has a conical shape, a pyramidal shape, a hollow cylindrical shape, a round pillar shape, or a polygonal pillar shape.

3. The method for producing a liquid crystal display device according to claim 1,
wherein the support column is black.

4. The method for producing a liquid crystal display device according to claim 3,
wherein at least a surface of the support column contains black fluororesin.
